(19) United States
(12) Patent Application Publication
(10) Pub. No.: US 2006/0245408 A1
(43) Pub. Date: Nov. 2, 2006

(54) System and method for interworking between cellular network and wireless LAN

(75) Inventors: Sang-Do Lee, Suwon-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/413,176

(22) Filed: Apr. 28, 2006

(30) Foreign Application Priority Data
Apr. 29, 2005 (KR) 2005-36425

(51) Int. Cl. H04Q 7/24; H04L 12/56

(52) U.S. Cl. 370/338; 370/401

(57) ABSTRACT

A method and system for providing a packet data service of a cellular network to an access terminal (AT) that accessed a wireless local area network (LAN) are provided. The AT accessing the wireless LAN transmits a session request message. Once the session request message is received, an interworking—entry server (IES) sends an authentication request for the AT, and after completing authentication on the AT, transmits a session response message to the AT. Once the session response message is received, the AT sets up a generic routing encapsulation (GRE) tunnel to an interworking—packet control function (I-PCF). The I-PCF sets up a GRE tunnel to a packet data serving node (PDSN) that provides the packet data service to the AT. The AT exchanges packet data with the PDSN.

### PRIORITY

This application claims the benefit under 35 U.S.C. § 119(a) of Korean Patent Application filed in the Korean Intellectual Property Office on Apr. 29, 2005 and assigned Serial No. 2005-36425, the entire disclosure of which is hereby incorporated by reference.

### BACKGROUND OF THE INVENTION

1. Field of the Invention

The present invention relates generally to a system and method for interworking between different wireless communication systems. More particularly, the present invention relates to a tightly-coupled interworking system and method between a cellular network and a wireless Local Area Network (LAN).

2. Description of the Related Art

Wireless communication systems have been developed for terminals that cannot be connected to the fixed wire networks. Examples of typical wireless communication systems include mobile communication systems, Wireless LANs, Wireless Broadband (WiBro), and Mobile Ad Hoc, among others.

The objective of mobile communication is to permit subscribers to enjoy calls while on the move over a broad area at high speed. An example of this type of mobile communication system is a cellular system. The cellular system, proposed to overcome the limited service area and subscriber capacity of the conventional mobile communication system, divides its service area into several small zones or cells. The cellular system also allows the cells sufficiently spaced from each other to use the same frequency band, thereby spatially reusing the frequency. The earliest technology for the cellular system includes Advanced Mobile Phone System (AMPS) and Total Access Communication Services (TACS). AMPS and TACS are both analog technologies, and this is called a 1^{st} generation mobile communication system. The 1^{st} generation mobile communication system did not have the capacity to cope with the rapidly increasing number of mobile communication service subscribers. The development of communication technology brought demands for a variety of advanced services in addition to the conventional voice service. To meet the demands, a 2^{nd} generation digital mobile communication system was proposed. This 2^{nd} generation digital mobile communication system is advanced from the 1^{st} generation analog mobile communication system. The 2^{nd} generation mobile communication system, unlike the analog communication system, digitalizes analog voice signals before voice coding, and performs digital modulation/demodulation using a frequency band of 800 MHz. The multiple access technology used in the 2^{nd} generation mobile communication system includes Time Division Multiple Access (TDMA) and Code Division Multiple Access (CDMA). The 2^{nd} generation mobile communication system provides a voice service and a low-speed data service. The 2^{nd} generation mobile communication system is classified into an IS-95 CDMA system and an IS-54 TDMA system, both proposed in the United States, and a Global System for Mobile communication (GSM) system proposed in Europe. Also, a Personal Communication Services (PCS) system is classified as a 2.5^{th} generation mobile communication system, and uses a frequency band of 1.8 to 2 GHz. The 2^{nd} generation mobile communication systems were deployed with the objective of providing voice service to users at high system efficiency. However, the Internet and the increasing users' demands for high-speed data service have led to the arrival of a new wireless platform, such as, the 3^{rd} generation mobile communication system such as an International Mobile Telecommunication-2000 (IMT-2000) system.

Following the 3^{rd} generation mobile communication system, a 4^{th} generation mobile communication system has been introduced. The 4^{th} generation mobile communication system allows users to access all of a satellite network, a Wireless LAN, and the Internet with one mobile terminal. Also, the 4^{th} generation mobile communication system is much higher in data rate than the 3^{rd} generation mobile communication system, so it can provide users with higher-speed data service.

The technologies popularly used to provide data service to users in the current wireless communication environment are classified into a 2.5^{th} or 3^{rd} generation cellular mobile communication technology such as CDMA 2000 1x/1x Evolution Voice—Data Only (EV-DO), Global Packet Radio Services (GPRS) and Universal Mobile Telecommunication System (UMTS), and a Wireless LAN technology such as IEEE 802.11 Wireless LAN and High Performance Radio LAN (HIPERLAN) 1/2.

The Wireless LAN is a flexible data communication system realized through an extension of the wired LAN, or realized as an alternative to the wired LAN. In the Wireless LAN, a mobile terminal transmits/receives data over the air channel using the radio frequency (RF) or infrared technology without cable connection, and can access the Internet by accessing an access point, enabling networking between users. The typical Wireless LAN can include IEEE 802.11-based WiFi.

FIG. 1 is a diagram illustrating a general network configuration of a CDMA 2000 1x EV-DO system. As illustrated in FIG. 1, the CDMA 2000 1x EV-DO system includes a data core network 122 and an access network 120. An Access Terminal (AT) 100 accesses an Access Network Transmission System (ANTS) 102 that handles a signaling procedure for processing origination and termination of a packet call, and a packet delivery procedure. The ANTS 102 also handles radio links and radio signals with an IS-856 wireless access standard defining Medium Access Control (MAC). The ANTS 102 is connected to an Access Network Controller (ANC) 104 that takes charge of call control and resource management. FIG. 1 illustrates the ANC 104 connected to only one ANTS 102 for convenience. In reality, the ANC 104 can be connected to more than two ANTSs. The ANC 104 is connected, via a Packet Control Function (PCF) 108, to a Packet Data Serving Node (PDSN) 112 of the data core network 122, which takes charge of authentication, Internet protocol (IP) address assignment and routing functions for the AT 100. The PCF 108 takes charge of a user traffic delivery function between the ANC 104 and the PDSN 112, and may include a Session Control/Mobility Management (SCMM) that takes charge of session management and mobility management for the AT 100 and authentication for the AT 100. In FIG. 1, the PCF 108 of the access network 120 currently accessed by the AT 100 is called a ‘source PCF’ and a PCF 110 of a target access network during handoff of the AT 100 is called a ‘target PCF’. Also, the PCF 108 is connected to an Access Network-Authentication Authorization Accounting (AN-AAA) server 106, which is a network server for taking charge of authentication, authorization and accounting functions for users, the target PCF 110, and the PDSN 112 of the data core network 122.

Interfaces between the network elements described above are now briefly described. An A8 interface handles user traffic exchanged between the ANC 104 and the source PCF 108, an A9 interface defines a signaling procedure for origination, release and termination of a packet call between the ANC 104 and the PCF 108, and an A14 interface defines a signaling procedure for delivery of information related to CDMA 2000 1x EV-DO session and mobility between the ANC 104 and the PCF 108. An A13 interface defines a signaling procedure for delivering session information between the target SCMM 110 and the source SCMM 108 during handoff, and an A12 interface defines a signaling procedure for AT authentication and mobile identity delivery for the AT 100 between the SCMM 108 and the AN-AAA server 106. An A10 interface handles user traffic exchanged between the PCF 108 and the PDSN 112, and an A11 interface defines a signaling procedure for origination and release of a packet call between the PCF 108 and the PDSN 112. The PDSN 112 of the data core network 122, connected to the source PCF 108 via the A10/A11 interfaces, is connected to an AAA server 114 of the data core network 122 with Remote Authentication Dial—In User Service (RADIUS), and is also connected to a Home Agent (HA) 118 to receive Mobile IP, and exchanges packets with an external network (not shown) via the external Internet 116.

The most noticeable characteristics of the 3^{rd} generation cellular mobile communication technologies that evolved from the 1^{st} and 2^{nd} generation mobile communication technologies that mainly provide voice service via circuit networks, are that they provide packet data service capable of allowing subscribers to access the Internet in the broadband wireless communication environment. However, there is a limitation in supporting high-speed packet data service in the cellular communication network, and the CDMA 2000 1x EV-DO system, which is a synchronous mobile communication system, supports a data rate of up to 2.4 Mbps.

In parallel with the evolution of the mobile communication technologies, there is the advent of various local wireless access technologies such as IEEE 802.11-based Wireless LAN, High Performance Radio LAN (HIPERLAN)/2, and Bluetooth. These technologies cannot guarantee the mobility on the same level as that of the cellular mobile communication system. However, these technologies were presented as an alternative for providing high-speed data service in a wireless environment, replacing the wired communication networks such as cable modem or xDSL in a hot spot zone including public places such as schools, or in a home network environment. For example, the Wireless LAN based on an IEEE 802.11b standard supports a data rate of about 11 Mbps in a 2.4 GHz Industrial Scientific Medical (ISM) band, and the Wireless LAN based on an IEEE 802.11a standard supports a data rate of a maximum of 54 Mbps in a 5 GHz band, and can provide high-speed wireless data service at low installation cost.

FIG. 2 is a diagram illustrating a general network configuration of a Wireless LAN. In FIG. 2, an AT 200 accesses an adjacent Access Point (AP) 202 of a Wireless LAN (WLAN) 212 according to an IEEE 802.11 wireless interface standard and the AP 202 is connected to an Access Router (AR) 204 of an IP network 214 via IEEE 802.2/Ethernet. The AR 204 is connected to an AAA server 206 that performs authentication and accounting for the AT 200, using RADIUS. Further, the AR 204 is connected to an HA 210 to provide Mobile IP to the AT 200 and to the Internet 208 to exchange packets with an external network (not shown).

When the Wireless LAN of FIG. 2 provides high-speed data service to the AT 200, public data network service provided to users is limited due to the limited mobility and service area. There is also a limitation in providing public data network service due to interference. In an effort to overcome the limitation, a portable Internet technology that makes up for the defects of the cellular mobile communication system and the Wireless LAN has been introduced. A WiBro system is a typical example of the portable Internet technology now under standardization and development. The WiBro system provides high-speed data service in an indoor/outdoor stationary environment and pedestrian-speed, mid/low-speed (about 60 Km/h) mobile environments, using various types of terminals. In the future wireless communication environment, various wireless access technologies supporting different data rates and mobilities will be presented. Providing a service capable of making up for the defects of the different technologies and satisfying various users' demands, requires a scheme capable of seamlessly providing voice and data services to the ATs that select and access an optimal wireless access network according to locations and service requirements of the users.

The rapid development of the wireless technologies, has led to many discussions on the development and deployment of the 4^{th} generation mobile communication system, following the introduction of the 3^{rd} generation mobile communication system. Various wireless access technologies are involved in the process of changing to the next generation mobile communication environment, and complementary and competitive relationships will be formed in each field. Therefore, until the next generation systems secure a stable position and form the perfect market, there is a need for technologies capable of interworking the existing 2.5^{th} or 3^{rd} generation cellular mobile communication system with the next generation mobile communication systems and providing the intact services provided in the existing cellular mobile communication system even in the new wireless environment.

For this purpose, many efforts to interwork the heterogeneous networks with each other have been made in the international standardization groups such as 3^{rd} Generation Partnership Project (3GPP) and 3^{rd} Generation Partnership Project 2 (3GPP2). For example, the 3GPP, which is the asynchronous mobile communication network standardization group, has classified the interworking technology into two types of interworking technologies according to a coupling point of a GPRS network and a Wireless LAN.

FIG. 3 is a diagram illustrating tightly coupled and loosely coupled technologies classified by the 3GPP according to the coupling point. With reference to FIG. 3, a description will now be made of the tightly coupled and loosely coupled technologies. Each of Mobile Stations (MSs) 300 and 302, or ATs in 3GPP2, accesses a UMTS Terrestrial Radio Access Network (UTRAN) 304 or a General Packet Radio Service Radio Access Network (GPRS RAN) 306, and performs communication therewith.

A loosely coupled technology 314 couples a Wireless LAN to an interface between a Gateway GPRS Support Node (GGSN) 312 (or PDSN in the 3GPP2) and an external IP network 316, and in this technology, the WLAN traffic does not pass through the core network (SGSN 310 and GGSN 312 in FIG. 3) of the cellular network. Therefore, implementing the loosely coupled technology 314 is easy because it enables interworking regardless of the access network technology and takes into account only the interworking with the AAA server. Further, the loosely coupled technology 314 excludes an influence to the core network of the cellular network caused by the WLAN traffic. However, the loosely coupled technology 314 is large in handoff delay and packet loss, and does not support Simple IP handoff.

However, a tightly coupled technology 308 couples a Wireless LAN to a Serving GPRS Support Node (SGSN) 310, or a PCF in the 3GPP2, which corresponds to the core network of the cellular network, and in this technology, the WLAN packet passes through the core network of the cellular network. The tightly coupled technology 308 is small in handoff delay and packet loss, and can support Simple IP handoff between the cellular network and the Wireless LAN, and can support Inter-Extended Service Set (Inter-ESS) handoff in a data link layer. However, the tightly coupled technology 308 requires implementation of an interworking gateway based on the access network technology, requires a change in the MS and the cellular network, and has an influence on the core network of the cellular network caused by the WLAN traffic.

Most of the technologies recently presented for the cellular network and the Wireless LAN use the loosely coupled technology 314. However, the loosely coupled technology 314 does not support handoff between the mobile communication system and the Wireless LAN based on Simple IP.

Accordingly, there is a need for a method and system of supporting handoff between the mobile communication system and the Wireless LAN based on Simple IP for the tightly coupled technology 308. Also, there is a need for a function of supporting handoff between the mobile communication system and the Wireless LAN based on Mobile IP.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an interworking system and method between a cellular network and a Wireless LAN based on tightly coupled technology.

It is another object of an exemplary embodiment of the present invention to provide a system and method for seamless handoff between a cellular network and a Wireless LAN to access terminals that use Simple IP or Mobile IP, without modification of the existing network devices.

Another object of an exemplary embodiment of the present invention is to provide a system and method in which subscribers of a cellular network can receive data service of the cellular network even though they access a Wireless LAN.

According to one aspect of an exemplary embodiment of the present invention, a system provides a packet data service of a cellular network to an access terminal (AT) that accessed a wireless local area network (LAN). The system comprises the AT, an interworking—entry server (IES), and an interworking—packet control function (I-PCF). The AT f transmits a session request message to an interworking—entry server (IES) by accessing the wireless LAN, and sets up a generic routing encapsulation (GRE) tunnel to an interworking—packet control function (I-PCF) to receive the packet data service. The IES performs authentication on the AT once the session request message is received from the AT, and transmits a session response message including an IP address of the I-PCF to the AT. The I-PCF sets up a GRE tunnel to the AT, and sets up a GRE tunnel to a packet data serving node (PDSN) that provides the packet data service to the AT, based on session information of the AT.

According to another aspect of an exemplary embodiment of the present invention, there is a method for providing a packet data service of a cellular network to an access terminal (AT) that accessed a wireless local area network (LAN). A session request message is transmitted by the AT accessing the wireless LAN. An authentication request for the AT is sent by an interworking—entry server (IES) once the session request message is received. After authentication on the AT is completed, a session response message is transmitted to the AT. A generic routing encapsulation (GRE) tunnel is set up, by the AT, to an interworking—packet control function (I-PCF) once the session response message is received. A GRE tunnel set up, by the I-PCF, to a packet data serving node (PDSN) and provides the packet data service to the AT. Packet data is exchanged between the AT and the PDSN.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will become more apparent from the following detailed description when taken in conjunction with the accompanying drawings in which:

FIG. 1 is a diagram illustrating a general network configuration of a CDMA 2000 1x EV-DO system;

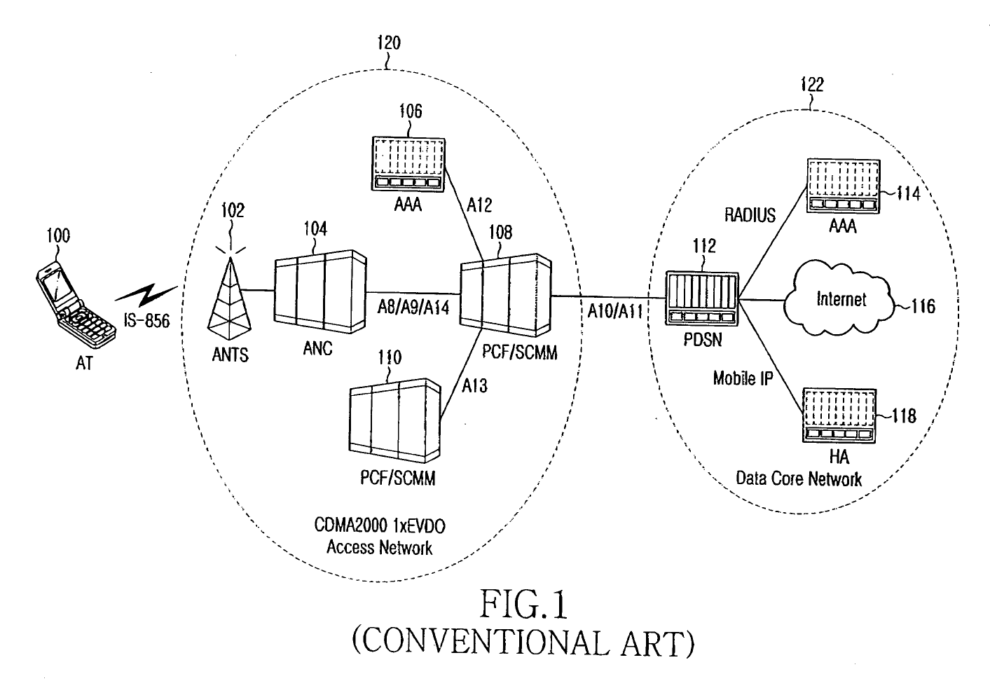

FIG. 2 is a diagram illustrating a general network configuration of a Wireless LAN;

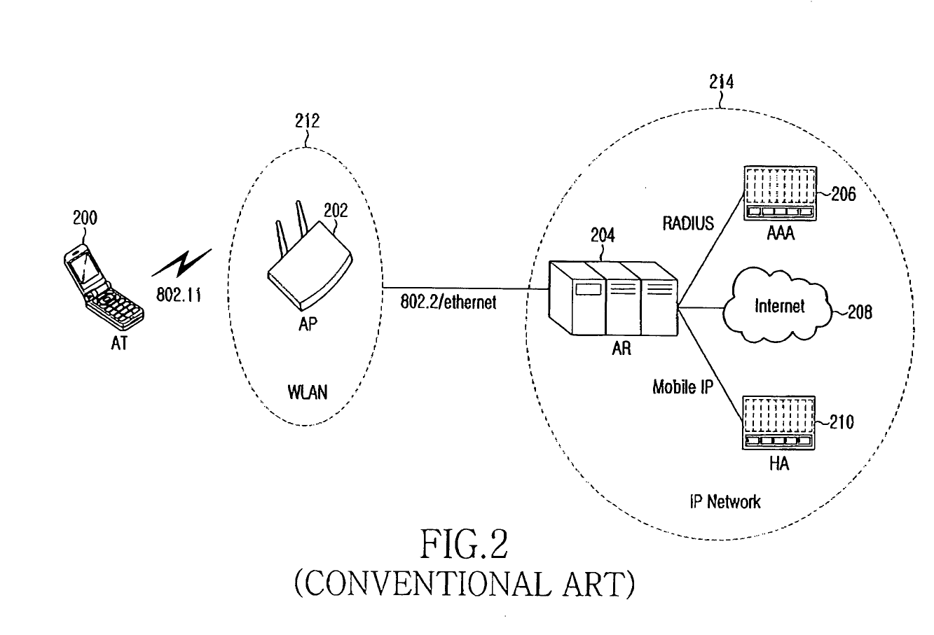

FIG. 3 is a diagram illustrating tightly coupled and loosely coupled technologies classified by 3GPP according to a coupling point;

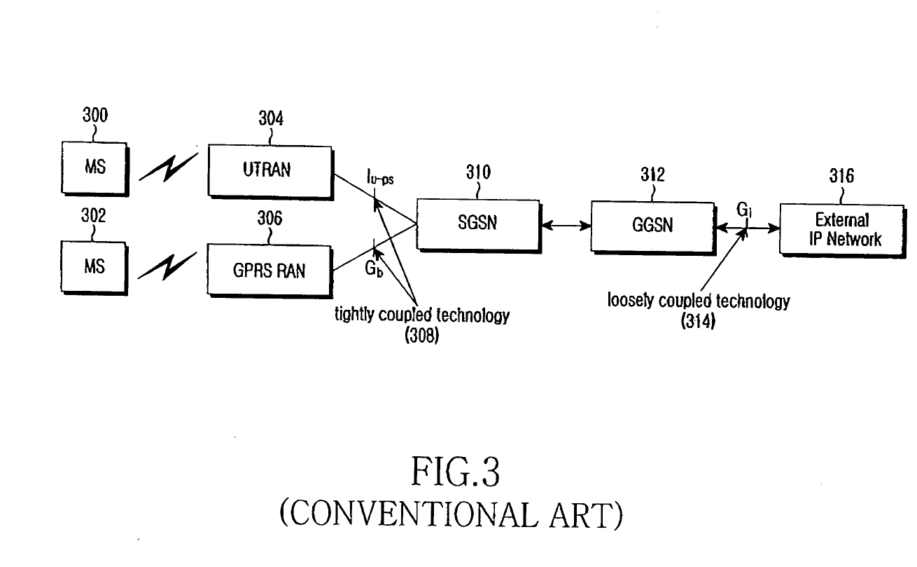

FIG. 4 is a diagram illustrating a network reference model for interworking between a CDMA 2000 1x EV-DO network and a Wireless LAN (or WiBro network) according to an exemplary embodiment of the present invention;

FIG. 5 is a block diagram of an I-PCF according to an exemplary embodiment of the present invention;

FIG. 6 is a block diagram of an IES according to an exemplary embodiment of the present invention;

FIG. 7 is a diagram illustrating a traffic delivery path for 3G mobile communication data service provided to an AT located in a Wireless LAN according to an exemplary embodiment of the present invention;

FIG. 8 is a diagram illustrating a successful system access procedure of an AT located in a Wireless LAN according to an exemplary embodiment of the present invention;

FIG. 9 is a diagram illustrating a handoff procedure from a Wireless LAN to a CDMA 1x EV-DO network according to an exemplary embodiment of the present invention;

FIG. 10 is a diagram illustrating an inter-network handoff procedure from a CDMA 1x EV-DO network to a Wireless LAN according to an exemplary embodiment of the present invention;

FIG. 11 is a block diagram of an AT for interworking between a cellular network and a Wireless LAN according to an exemplary embodiment of the present invention;

FIG. 12 is a flowchart illustrating a control flow in which an AT accessing a Wireless LAN receives 3G data service provided in a CDMA 2000 1x EV-DO network according to an exemplary embodiment of the present invention;

FIG. 13 is a flowchart illustrating an inter-network handoff procedure performed when an AT moves from a Wireless LAN to a CDMA 2000 1x EV-DO network according to an exemplary embodiment of the present invention; and

FIG. 14 is a flowchart illustrating an inter-network handoff procedure performed when an AT moves from a CDMA 2000 1x EV-DO network to a Wireless LAN according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention is described. An exemplary embodiment of the present invention provides the data service provided in the existing 3^{rd} generation mobile communication system to the subscribers that can simultaneously access the 3^{rd} generation mobile communication and the next generation communication technology through the next generation communication technology (Wireless LAN or WiBro) based wireless access network in the indoor/outdoor or wire/wireless integrated environment. Also, an exemplary embodiment of the present invention uses a CDMA 2000 1x EV-DO system as an example of the 3^{rd} generation cellular network, and uses the WiBro system and Wireless LAN as the typical next generation communication technologies. A detailed description is made of tightly-coupled interworking between the CDMA 2000 1x EV-DO system and the Wireless LAN or between the CDMA 2000 1x EV-DO system and the WiBro network.

To achieve the above and other objects, an exemplary embodiment of the present invention presents a network configuration for interworking between a CDMA 2000 1x EV-DO network and a Wireless LAN or between a CDMA 2000 1x EV-DO network and a WiBro network. A Wireless LAN includes a WiBro network. However, when the Wireless LAN does not need to include the WiBro network, the Wireless LAN will be classified as an IEEE 802.11 network and the WiBro network will be classified as an IEEE 802.16 network. Therefore, the term “Wireless LAN” includes both the Wireless LAN and the WiBro network in the following description.

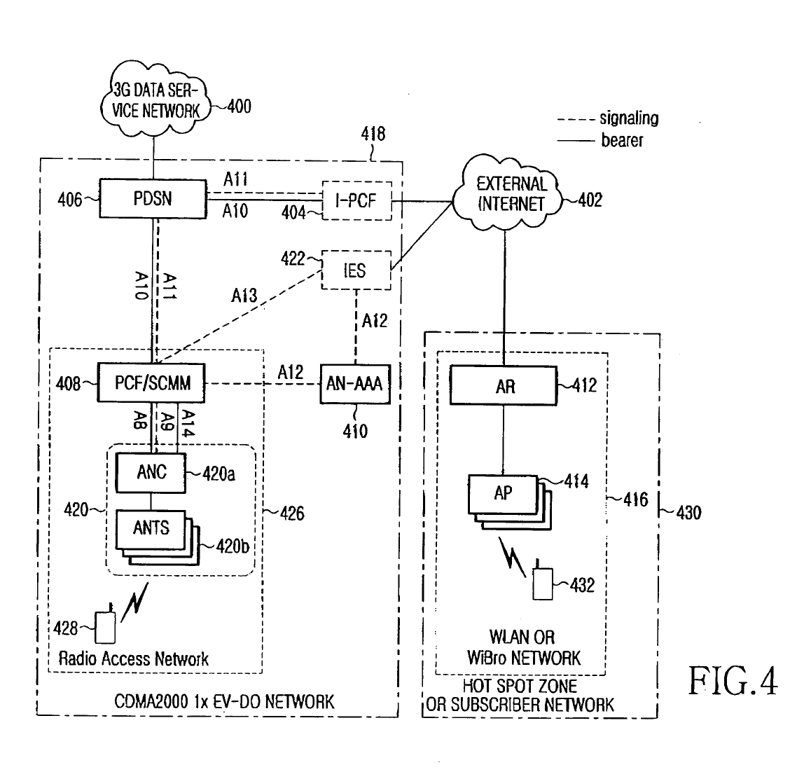

A first embodiment provides 3G data service to a CDMA 2000 1x EV-DO service subscriber that accessed the Wireless LAN. A second embodiment provides a handoff method for situations in which a subscriber accessing the Wireless LAN moves to a CDMA 2000 1x EV-DO network area. A third embodiment provides a handoff method for the case where a subscriber accessing the CDMA 2000 1x EV-DO network moves to a Wireless LAN area. FIG. 4 illustrates an interworking architecture between a CDMA 2000 1x EV-DO network and a Wireless LAN according to an exemplary embodiment of the present invention.

FIG. 4 is a diagram illustrating a network reference model for interworking between a CDMA 2000 1x EV-DO network and a Wireless LAN according to an exemplary embodiment of the present invention. A definition of interfaces between the CDMA 2000 1x EV-DO network and the Wireless LAN is given in Table 1 below.

TABLE 1

| Interface | Description |
|---|---|
| IS-856 | This is a wireless access standard defined between AT and ANTS, and includes a signaling |
| | procedure for processing origination and termination of packet call, a packet delivery |
| | procedure, and a protocol for determining MAC. |
| A8 | This is an interface standard for processing user traffic exchanged between ANC and PCF. |
| A9 | This is an interface standard for defining a signaling procedure for origination, release and |
| | termination of a packet call between ANC and PCF. |
| A10 | This is an interface standard for processing user traffic exchanged between PCF and PDSN. |
| A11 | This is an interface standard for defining a signaling procedure for origination and release of |
| | packet call between PCF and PDSN. |
| A12 | This is an interface standard for defining a signaling procedure for UE authentication and |
| | MNID (Mobile Node Identifier) delivery between SCMM and AN-AAA. |
| A13 | This is an interface standard for defining a signaling procedure for delivering session |
| | information between target SCMM and source SCMM when intersystem handoff occurs. |
| A14 | This is an interface standard for defining a signaling procedure for delivering CDMA2000 |
| | 1x EV-DO session and mobility-related information between ANC and SCMM of |
| | CDMA2000 1x EV-DO system. |

The network architecture of FIG. 4 includes 4 parts of a CDMA 2000 1x EV-DO network 418 for providing CDMA 2000 1x EV-DO service to an Access Terminal (AT), a Wireless LAN 416 for providing IEEE 802.11 or WiBro service, an external Internet 402, connected to each of the CDMA 2000 1x EV-DO network 418 and the Wireless LAN 416, for exchanging IP packets therewith, and a 3G data service network 400, connected to the CDMA 2000 1x EV-DO network 418, for providing 3G mobile communication service.

The CDMA 2000 1x EV-DO network 418 includes a PDSN 406, a Radio Access Network 426, an Access Network Authentication Authorization Accounting (AN-AAA) server 410, an Interworking—Packet Control Function (I-PCF) 404, and an Interworking—Entry Server (IES) 422. The I-CPF 404 and the IES 422 are both new additions according to an exemplary embodiment of the present invention. A description will now be made of each of the network elements (NEs).

The PDSN 406, connected to the 3G data service network 400, takes charge of authentication, IP address assignment and routing functions for an AT 428 that accessed the CDMA 2000 1x EV-DO network 418. The I-PCF 404 takes charge of a traffic delivery function between an AT 432 of a mobile communication service subscriber accessing the Wireless LAN 416 and the PDSN 406. The IES 422 takes charge of a function of authenticating a mobile communication subscriber accessing the Wireless LAN 416 and assigning the I-PCF 404 to the AT. The AN-AAA server 410 takes charge of authentication, authorization and accounting functions for the user. In an exemplary embodiment of the present invention, an ANC 420a and an ANTS 420b constitute an access network 420.

A Packet Control Function (PCF) takes charge of a user traffic delivery function between the access network 420 and the PDSN 406 of the CDMA 2000 1x EV-DO network 418. A Session Control Mobility Management (SCMM) takes charge of session management, mobility management, and AT authentication functions for the AT 428 accessing the CDMA 2000 1x EV-DO network 418. Although the PCF and the SCMM are united into one NE of a PCF/SCMM 408 in the exemplary embodiment of the present invention, they may also be independently provided. The Radio Access Network 426 of FIG. 4 includes the PCF/SCMM 408, the Access Network Controller (ANC) 420a, and the Access Network Transceiver System (ANTS) 420b.

In FIG. 4, the Wireless LAN 416 deployed in a hot spot zone or an enterprise network 430 includes an Access Router (AR) 412 for performing authentication, IP address assignment and routing functions for the AT 432 accessing the Wireless LAN 416. The Wireless LAN 416 also includes an Access point (AP) 414 for connecting with the AT 432 accessing the Wireless LAN 416, with a wireless interface. In FIG. 4, the dotted line represents a signal flow for signaling between the NEs, and the bold solid line represents an actual data flow. The ATs 428 and 432 may be connected to the same PDSN 406 when they move between the Wireless LAN 416 and the CDMA 2000 1x EV-DO network 418. There are also situations (not shown) in which the ATs 428 and 432 are connected to different PDSNs.

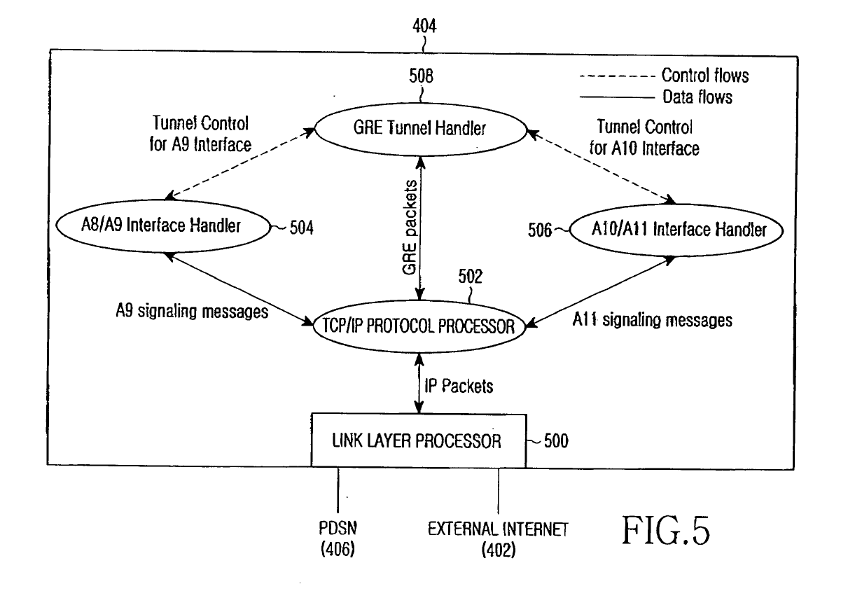

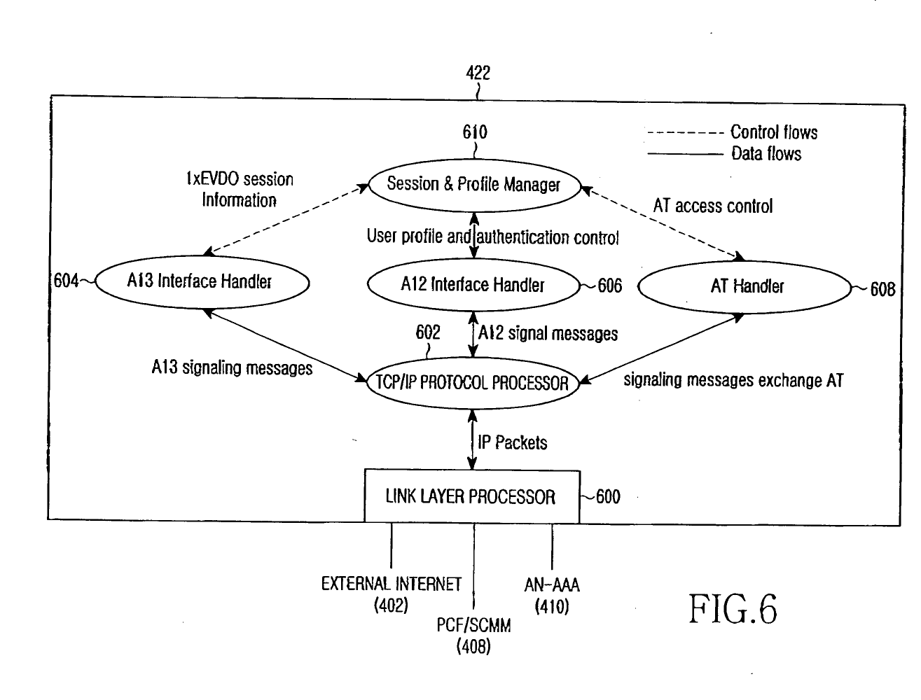

With reference to FIGS. 5 and 6, a detailed description will now be made of the IES 422 and the I-PCF 404, the newly added NEs, according to an exemplary embodiment of the present invention.

FIG. 5 is a block diagram of an I-PCF 404 according to an exemplary embodiment of the present invention. A link layer processor 500, physically connected to the external Internet 402, and the PDSN 406 or the ATs 428 and 432, handles user traffic or signaling messages according to a link layer protocol. A TCP/IP protocol processor 502 handles user traffic and signaling messages delivered to the external Internet 406 and the PDSN 406 or the ATs 428 and 432 via the I-PCF 418 according to a Transmission Control Protocol (TCP)/Internet Protocol (IP) protocol. An A8/A9 interface handler 504 handles A9 signaling messages exchanged between the AT 432 accessing the Wireless LAN and the I-PCF 404. The A8/A9 interface handler 504 also controls a Generic Routing Encapsulation (GRE) tunnel according to the result, performing a function of generating or releasing an A8 interface.

An A10/A11 interface handler 506 handles A11 signaling messages exchanged between the PDSN 406 and the I-PCF 404. The A10/A11 interface handler 506 also controls a GRE tunnel according to the result, thereby generating or releasing an A10 interface. A GRE tunnel handler 508 generates or eliminates a GRE tunnel in response to a request from the A8/A9 interface handler 504 or the A10/A11 interface handler 506, and handles GRE packets exchanged between the ATs 428 and 432 and the I-PCF 404, and handles GRE packets exchanged between the PDSN 406 and the I-PCF 404.

FIG. 6 is a block diagram of an IES 422 according to an exemplary embodiment of the present invention. In the exemplary embodiment of the present invention, the signaling messages exchanged between the ATs 428 and 432 and the IES 422 are delivered using a User Datagram Protocol (UDP).

A link layer processor 600 handles the signaling or user traffic messages exchanged between the IES 422 and the external Internet 402, the PCF/SCMM 408, the AN-AAA server 410 or the ATs 428 and 432 according to a link layer protocol. A TCP/IP protocol processor 602 handles user traffic or signaling messages delivered to the external Internet 402, the PCF/SCMM 408, the AN-AAA server 410, or the ATs 428 and 432 via the IES 422 according to a TCP/IP protocol. An A13 interface handler 604 handles A13 signaling messages used for delivering CDMA 2000 1x EV-DO session information between the PCF/SCMM 408 and the IES 422 of the CDMA 2000 1x EV-DO network 418. An A12 interface handler 606 handles A12 signaling messages used for delivering authentication information between the IES 422 and the AN-AAA server 410. An AT handler 608 handles signaling messages exchanged between the AT 432 accessing the Wireless LAN 416 and the IES 422.

A session & profile manager 610 generates and stores a virtual CDMA 2000 1x EV-DO session using information on the AT 432, delivered by the AT handler 608 that received a session request message from the AT 432 when the AT 432 accesses the Wireless LAN 416. The session & profile manager 610 delivers the generated virtual CDMA 2000 1x EV-DO session information to the CDMA 2000 1x EV-DO network 418 via the A13 interface handler 604 when the AT 432 moves to the CDMA 2000 1x EV-DO network 418.

However, when the AT 428 accessing the CDMA 2000 1x EV-DO network 418 moves to the Wireless LAN 416, the session & profile manager 610 acquires session information of the CDMA 2000 1x EV-DO network 418 for the AT 428 by delivering, to the A13 interface handler 604, information (IP address of PCF/SCMM, found using UATI assigned to the AT) on the PCF/SCMM 408, delivered by the AT handler 608. In an exemplary embodiment of the present invention, the IES 422 should manage the session information since an operation for the movement from the cellular network to the Wireless LAN is performed according to a handoff procedure between PCF/SCMMs.

The IES 422 also stores a user profile delivered from the AN-AAA server 410 through an authentication process.

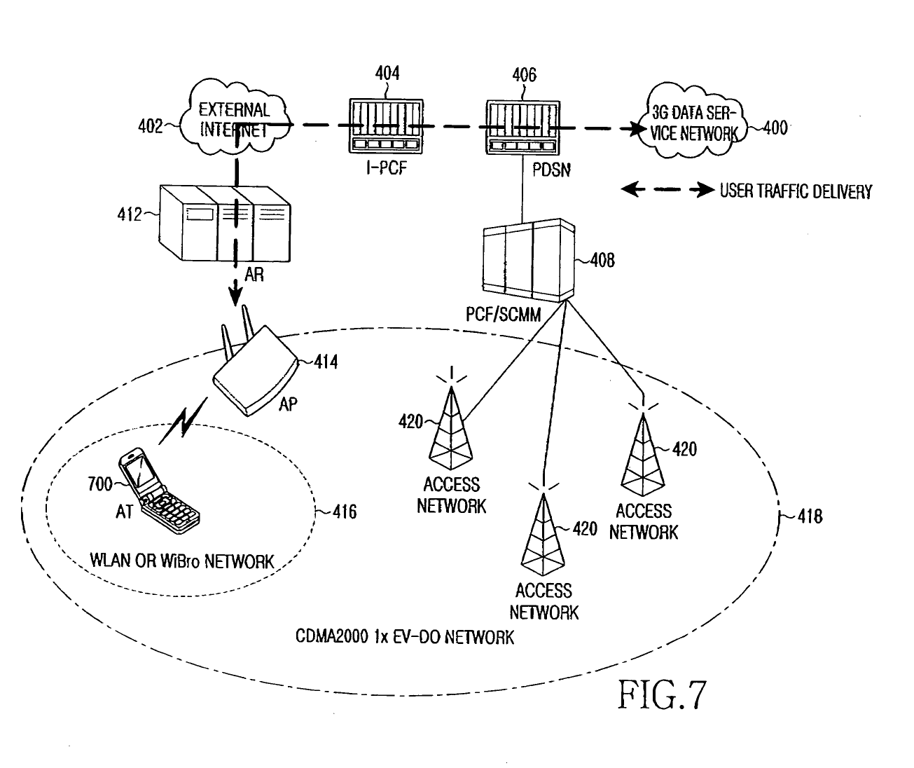

FIG. 7 is a diagram illustrating a traffic delivery path for 3G mobile communication data service provided to an AT 700 located in a Wireless LAN 416 according to an exemplary embodiment of the present invention. In the exemplary embodiment of the present invention, the 3^{rd} generation mobile communication is the CDMA 2000 1x EV-DO system, and the bold dotted line represents a path of the traffic delivered to the AT 700 accessing the Wireless LAN 416. When a server located in a 3G data service network 400 transmits packets to the AT 700, the packets are delivered to a PDSN 406 of a CDMA 2000 1x EV-DO network 418 and delivered again to the AT 700 via an I-PCF 404 through an AR 412 and an AP 414 of the Wireless LAN 416 where the AT 700 is located. Alternatively, when the AT 700 located in the Wireless LAN 416 transmits packets to the server located in the 3G data service network 400, the packets delivered to the AR 412 via the AP 414 are re-delivered to the server of the 3G data service network 400 via the PDSN 406 located in the CDMA 2000 1x EV-DO network 418.

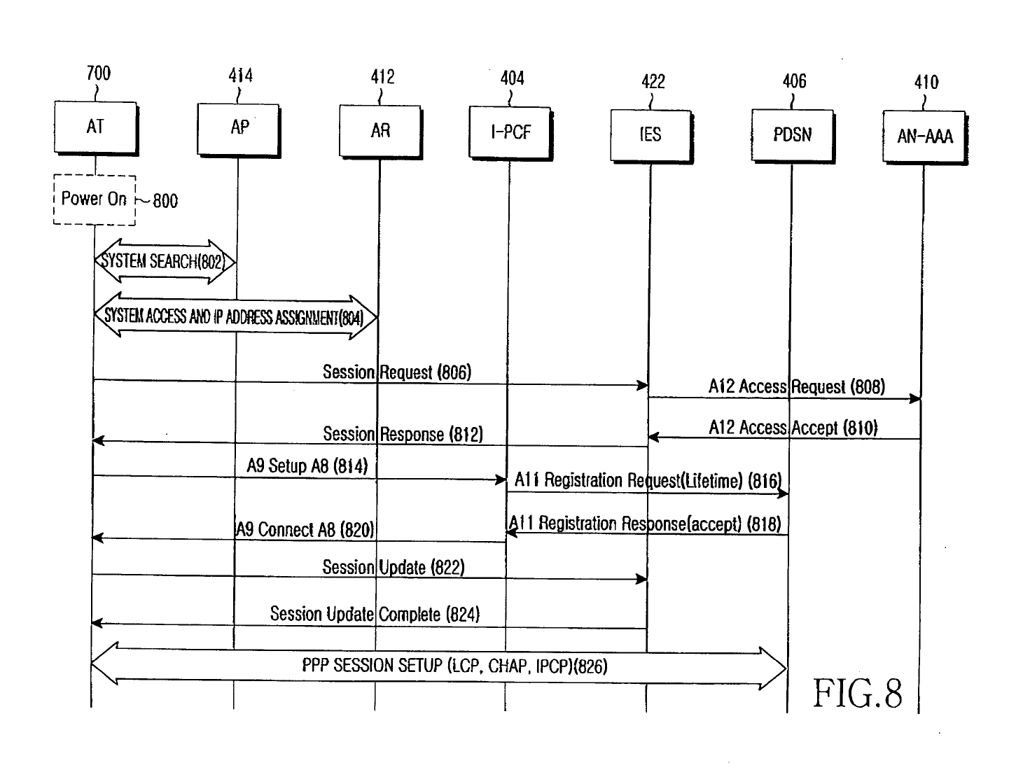

FIG. 8 is a diagram illustrating a successful system access procedure of an AT 700 located in a Wireless LAN 416 according to an exemplary embodiment of the present invention. According to FIG. 8, the AT 700 accessing the Wireless LAN 416 can receive 3G data service provided by a CDMA 2000 1x EV-DO network 418. A description for the case where the AT 700 fails in system access is not provided.

If the AT 700 located in the Wireless LAN 416 is first powered on in step 800, the AT 700 searches adjacent APs in a WLAN operating frequency band in step 802. In step 804, the AT 700 attempts to access the Wireless LAN 416 for an AP 414 selected from the adjacent APs. If a wireless link between the AT 700 and the AP 414 is successfully set up, an AR 412 assigns an IP address to the AT 700. The IP address assigned to the AT 700 is used for exchanging signaling messages between the AT 700 and an IES 422 or an I-PCF 404, or setting up a tunneling path between the AT 700 and the I-PCF 404.

In step 806, after completing the access to the Wireless LAN 416, the AT 700 generates a Session Request message and delivers the generated Session Request message to the IES 422. The Session Request message generated by the AT 700 includes a user ID, a password, and an IP address assigned from the Wireless LAN 416. A format of the Session Request message is shown in Table 2 below.

TABLE 2

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 1 | Length = variable | Option = 1 | Length = 4 |

IP address of access terminal

| | | |
|---|---|---|
| Option = 2 | Length = variable | . . . |

User ID
. . .

| | | |
|---|---|---|
| Option = 3 | Length = variable | . . . |

Password
. . .

In step 808, the IES 422 that receives the Session Request message generates an A12 Access Request message and delivers the generated A12 Access Request message to an AN-AAA server 410. The IES 422 generates a challenge value and a response value of a Challenge Handshake Authentication Protocol (CHAP) using the user ID and the password included in the Session Request message, and includes these values in the A12 Access Request message. The detailed format and contents of the A12 Access Request message generated by the IES 422 may follow a High Rate Packet Data Inter-Operability Specification (HRPD IOS) standard defined in 3GPP2 Technical Specification Groups-Access Network Interfaces (TSG-A). Exemplary embodiments of the present invention are not limited to the foregoing message and signaling standards, and can also be implemented using other standards. A detailed operation performed by the IES 422 in steps 806 and 808 will be described with reference to FIG. 6.

If the link layer processor 600 transmits the received Session Request message to the TCP/IP protocol processor 602, the TCP/IP protocol processor 602 delivers the Session Request message to the AT handler 608, determining that the Session Request message was transmitted by the AT 700 accessing the Wireless LAN 416. The AT handler 608 transmits information on the AT 700, included in the Session Request message, to the session & profile manager 610. To receive user authentication from the AN-AAA server 410, the A12 interface handler 606 generates an A12 Access Request message under the control of the session & profile manager 610 to request user authentication for the AT 700 and receive a response from the AN-AAA server 410. Also, the A12 interface handler 606 controls the TCP/IP protocol processor 602 to transmit the A12 Access Request message to the AN-AAA server 410.

In step 810, if the AN-AAA server 410 succeeds in authentication for the AT 700, it generates an A12 Access Accept message including a Mobile Identity (also known as a Mobile Node Identifier (MNID)) of the AT 700 and delivers the generated A12 Access Accept message to the IES 422. The detailed format and contents of the A12 Access Accept message generated by the AN-AAA server 410 follow the HRPD IOS standard defined in 3GPP2 TSG-A.

In step 812, the IES 422 that receives the A12 Access Accept message generates a Session Response message including an Access Network Identifier (ANID) of an access network to be accessed by the AT 700, a Mobile Identity, a Universal Access Terminal Identifier (UATI), and an IP address of the I-PCF 404. The IES 422 delivers the generated Session Response message to the AT 700.

When generating the Session Response message, the IES 422 assigns a UATI and an I-PCF for the AT 700 accessing the Wireless LAN 416. A format of the Session Response message is shown in Table 3 below.

TABLE 3

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 2 | Length = variable | Option = 4 | Length = 5 |

Access Network ID

| | | | |
|---|---|---|---|
| . . . | Option = 5 | Length = variable | . . . |

Mobile Identity
. . .

| | | |
|---|---|---|
| Option = 6 | Length = 16 | . . . |

. . .
UATI 128
. . .

| | | |
|---|---|---|
| . . . | Option = 7 | Length = 4 |

IP address of I-PCF

A detailed description of the operation in steps 810 and 812 will be made with reference to FIG. 6. The link layer processor 600 transmits the A12 Access Accept message received from the AN-AAA server 410 to the TCP/IP protocol processor 602. The TCP/IP protocol processor 602 transmits the A12 Access Accept message to the A12 interface handler 606 to handle the A12 Access Accept message, and the A12 interface handler 606 that receives the A12 Access Accept message delivers authentication information of the AT 700 to the session & profile manager 610. If authentication for the AT 700 is successfully performed, the session & profile manager 610 delivers the ANID, the Mobile Identity, the UATI, and the IP address of the I-PCF 404 to the AT handler 608. Then the AT handler 608 generates a Session Response message and transmits the generated Session Response message to the AT 700.

In step 814, the AT 700 generates an A9 Setup A8 message and delivers the generated A9 Setup A8 message to the I-PCF 404. The generation and delivery of the A9 setup A8 message occurs after acquiring the ANID, the Mobile Identity, the UATI, and the I-PCF IP address.

In step 816, the I-PCF 404 that receives the A9 Setup A8 message selects a PDSN 406 scheduled to transmit packets to the AT 700, generates an A11 Registration Request message and delivers the generated A11 Registration Request message to the selected PDSN 406. The detailed format and contents of the A11 Registration Request message generated by the I-PCF 404 follow the HRPD IOS standard defined in 3GPP2 TSG-A.

A detailed description of the operation in steps 814 and 816 will be made with reference to FIG. 5. The TCP/IP protocol processor 502 that receives the A9 Setup A8 message from the link layer processor 500 transmits the A9 Setup A8 message to the A8/A9 interface handler 504. The A8/A9 interface handler 504 generates an A8 interface for generating a GRE tunnel to the AT 700. After selecting the PDSN 406 scheduled to provide packet service to the AT 700, the GRE tunnel handler 508 allows the A10/A11 interface handler 506 to generate an A11 Registration Request message and transmit the generated A11 Registration Request message to the PDSN 406.

In step 818, the PDSN 406 that receives the A11 Registration Request message sets up a GRE tunnel to the I-PCF 404, generates an A11 Registration Response message, and delivers the generated A11 Registration Response message to the I-PCF 404. The detailed format and contents of the A11 Registration Response message generated by the PDSN 406 follow the HRPD IOS standard defined in 3GPP2 TSG-A. In step 820, the I-PCF 404 that receives the A11 Registration Response message sets up a GRE tunnel to the AT 700, generates an A9 Connect A8 message, and delivers the generated A9 Connect A8 message to the AT 700.

The operation in steps 818 and 820 are described in detail with reference to FIG. 5. Once an A11 Registration Response message is received from the PDSN 406 through the link layer processor 500, the TCP/IP protocol processor 502 transmits the A11 Registration Response message to the A10/A11 interface handler 506 to handle the A11 signaling messages. The A10/A11 interface handler 506 that receives the A11 Registration Response message allows the GRE tunnel handler 508 to set up a GRE tunnel to the PDSN 406. After setting up a GRE tunnel to the PDSN 406, the GRE tunnel handler 508 allows the A8/A9 interface handler 504 to generate an A9 Connect A8 message and transmit the generated A9 Connect A8 message to the AT 700 to generate a GRE tunnel to the AT 700.

In step 822, the AT 700 generates a Session Update message including an ANID, its own Mobile Identity and IP address, and IP addresses of the PDSN 406 and the I-PCF 404, and delivers the generated Session Update message to the IES 422. A format of the Session Update message is shown in Table 4 below.

TABLE 4

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 3 | Length = variable | Option = 4 | Length = 5 |

Access Network ID

| | | | |
|---|---|---|---|
| . . . | Option = 5 | Length = variable | . . . |

Mobile Identity
. . .

| | | |
|---|---|---|
| Option = 6 | Length = 16 | . . . |

. . .
UATI 128
. . .

| | | |
|---|---|---|
| . . . | Option = 7 | Length = 4 |

IP address of I-PCF

| | | |
|---|---|---|
| Option = 8 | Length = 4 | IP address of PDSN |

| | | |
|---|---|---|
| . . . | Option = 1 | Length = 4 |

IP address of access terminal

In step 824, the IES 422 that receives the Session Update message stores the ANID, the IP address of the AT 700, and the IP addresses of the I-PCF 404 and the PDSN 406 in the session information for the AT 700 accessing the Wireless LAN 416, generates a Session Update Complete message, and delivers the generated Session Update Complete message to the AT 700. A format of the Session Update Complete message is shown in Table 5 below.

TABLE 5

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 3 | Length = variable | Option = 8 | Length = 1 |
| Result code | | | |

A detailed description of the operation in steps 824 and 826 will be made with reference to FIG. 6. Once a Session Update message is received, the AT handler 608 transmits session information of the AT 700, included in the Session Update message, to the session & profile manager 610. After the session information of the AT 700 is stored, the session & profile manager 610 allows the AT handler 608 to generate a Session Update Complete message and transmit the Session Update Complete message to the AT 700.

In step 826, a Point-to-Point Protocol (PPP) session setup procedure is performed through the GRE tunnel (A8 interface) between the AT 700 and the I-PCF 404 and the GRE tunnel (A10 interface) between the I-PCF 404 and the PDSN 406. The detailed PPP session setup procedure performed between the AT 700 and the PDSN 406 follows the Wireless IP Network Standard defined in 3GPP2 TSG-P. In step 826, the AT 700 and the PDSN 406 perform Link Control Protocol (LCP) negotiation, Challenge Handshake Authentication Protocol (CHAP) authentication, and IP Control Protocol (IPCP) negotiation.

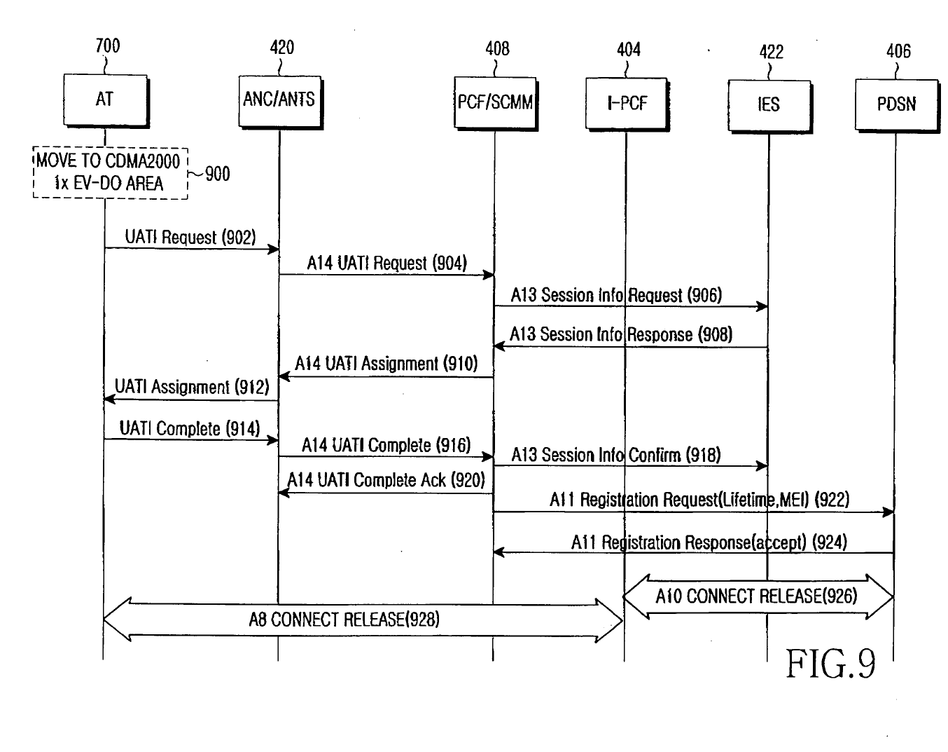

FIG. 9 describes a method for supporting handoff between heterogeneous networks (hereinafter referred to as “inter-network handoff or vertical handoff”), occurring when an AT 700 accessing a Wireless LAN 416 moves to a CDMA 2000 1x EV-DO network 418. This type of handoff occurs at the request of a user or an application layer in an area where the Wireless LAN 416 and the CDMA 2000 1x EV-DO network 418 overlap with each other. This type of handoff also occurs in the case where the AT 700 has completely left the coverage of the Wireless LAN 416 and can access only the CDMA 2000 1x EV-DO network 418.

FIG. 9 is a diagram illustrating a handoff procedure from a Wireless LAN 416 to a CDMA 1x EV-DO network 418 according to an exemplary embodiment of the present invention.

FIG. 9 does not consider situations in which the AT 700 fails in inter-network handoff. The detailed formats and contents of the signaling messages described in connection with FIG. 9 may follow the CDMA 2000 1x EV-DO wireless access standard and the interface standard defined in 3GPP2 TSG-C (CDMA 2000), TSG-A, and TSG-X (Intersystem Operations). Exemplary embodiments of the present invention are not limited to the foregoing message and signaling standards, and can also be implemented using other standards. A procedure performed when the AT 700 moves to the CDMA 2000 1x EV-DO network 418 is described. The AT 700 moves to the CDMA 2000 1x EV-DO network 418 while keeping the PPP session to the PDSN 406, such as, keeping the step 826 of FIG. 8, after succeeding in the system access procedure of FIG. 8 in the coverage of the Wireless LAN 416.

If the AT 700 moves from the Wireless LAN 416 to the CDMA 2000 1x EV-DO network 418 in step 900, the AT 700 searches/selects a system that it will access in a frequency band of the CDMA 2000 1x EV-DO network 418. The AT 700 then generates a UATI Request message defined in IS-856, and delivers the generated UATI Request message to an access network (ANC/ANTS) 420 in step 902. The UATI Request message includes a UATI value assigned to the AT 700 accessing the Wireless LAN 416, and the UATI Request message is disclosed in an IS-856 standard of CDMA 2000 1x EV-DO.

In step 904, the access network 420 that receives the UATI Request message generates an A14 UATI Request message and delivers the generated A14 UATI Request message to a PCF/SCMM 408. In this case, the PCF/SCMM 408 is a target PCF/SCMM 408 of the CDMA 2000 1x EV-DO network 418, to which the AT 700 moves and attempts an access.

In step 906, the PCF/SCMM 408 that receives the A14 UATI Request message generates an A13 Session Information Request message and delivers the A13 Session Information Request message to an IES 422 to acquire session information. At this moment, the PCF/SCMM 408 can distinguish the IES 422 providing a service to the AT 700 and can determine an IP address of the IES 422 depending on the UATI value included in the A14 UATI Request message. In the exemplary embodiment of the present invention, the PCF/SCMM 408 stores the UATI included in the A14 UATI Request message and an IP address of the IES 422, mapped to the UATI, so it can find an IP address of the IES 422 mapped to the AT 700.

In step 908, the IES 422 that receives the A13 Session Information Request message generates an A13 Session Information Response message including session information of the AT 700 and delivers the generated A13 Session Information Response message to the PCF/SCMM 408. The session information delivered by the IES 422 to the PCF/SCMM 408 includes a Mobile Identity, an ANID, and a PDSN IP address. The detailed operation in steps 906 and 908 will be described with reference to FIG. 6.

Once an A13 Session Information Request message is received, the A13 interface handler 604 transmits the session information of the AT 700 to the session & profile manager 610, generates an A13 Session Information Response message including the session information received from the session & profile manager 610, and transmits the A13 Session Information Response message to the PCF/SCMM 408.

Steps 910 to 920 correspond to a process of completing a session initialization procedure for the AT 700 accessing the CDMA 2000 1x EV-DO network 418. The detailed contents of this process is specified in the HRPD IOS standard defined in 3GPP2 TSG-A, so a detailed description thereof will be omitted herein.

In step 922, the PCF/SCMM 408 generates an A11 Registration Request message using the session information acquired in step 908, and delivers the A11 Registration Request message to the PDSN 406. The PCF of the PCF/SCMM 408 includes a Lifetime value>0 and a Mobility Event Indicator (MEI) field in the A11 Registration Request message. The PCF of the PCF/SCMM 408 selects the PDSN 406 depending on an IP address of the PDSN 406, included in the session information delivered by the IES 422. Therefore, the AT 700 can be connected to the same PDSN 406 as the PDSN 406 to which it was connected when it accessed the Wireless LAN 416.

In step 924, the PDSN 406 that receives the A11 Registration Request message generates an A11 Registration Response message and delivers the generated A11 Registration Response message to the PCF/SCMM 408. If the PDSN 406 has an IP packet to deliver to the AT 700, it includes a Data Available Indicator (DAI) in the A11 Registration Response message. Once the A11 Registration Response message is received including the DAI, the PCF/SCMM 408 performs a Network Initiated Call Reactivation procedure defined in HRPD IOS.

In step 926, the PDSN 406 starts an A10 connect release procedure with the I-PCF 404, recognizing that Inter-PCF handoff defined in the 3GPP2 IOS standard has occurred in step 924. The procedure of recognizing occurrence of the Inter-PCF handoff by the PDSN 406 may fallow the method defined in the 3GPP2 IOS standard.

In this case, the I-PCF 404 is a source I-PCF 404 of the Wireless LAN 416, to which the AT 700 was connected before it moves to the CDMA 2000 1x EV-DO network 418. Herein, the detailed contents for the A10 connect release between the PDSN 406 and the I-PCF 404 follow the HRPD IOS standard.

In step 928, the I-PCF 404, which released the A10 connect to the PDSN 406 in step 926, releases the A8 connect to the AT 700. The detailed contents for the A8 connect release between the I-PCF 404 and the AT 700 follow the HRPD IOS standard. After step 926 and 928, the AT 700 can receive packet data service from the PDSN 406 of the original cellular network without the need for setting up a tunnel to the I-PCF 404.

With reference to FIG. 9, if the AT 700 moves from the Wireless LAN 416 to the CDMA 1x EV-DO network 418, it can keep the old IP address used in the Wireless LAN 416 and the session of the upper layer. Therefore, the AT 700 can continue to provide the old application service performed before the handoff to the user even after the handoff. If the AT 700 moves from the Wireless LAN 416 to the CDMA 2000 1x EV-DO network 418 while transmitting IP traffic, it stops the IP packet transmission while the inter-network handoff is performed. After fully completing the procedure of FIG. 9, the AT 700 resumes the IP packet transmission after performing a packet call origination procedure based on the CDMA 2000 1x EV-DO wireless access standard and the HRPD IOS standard.

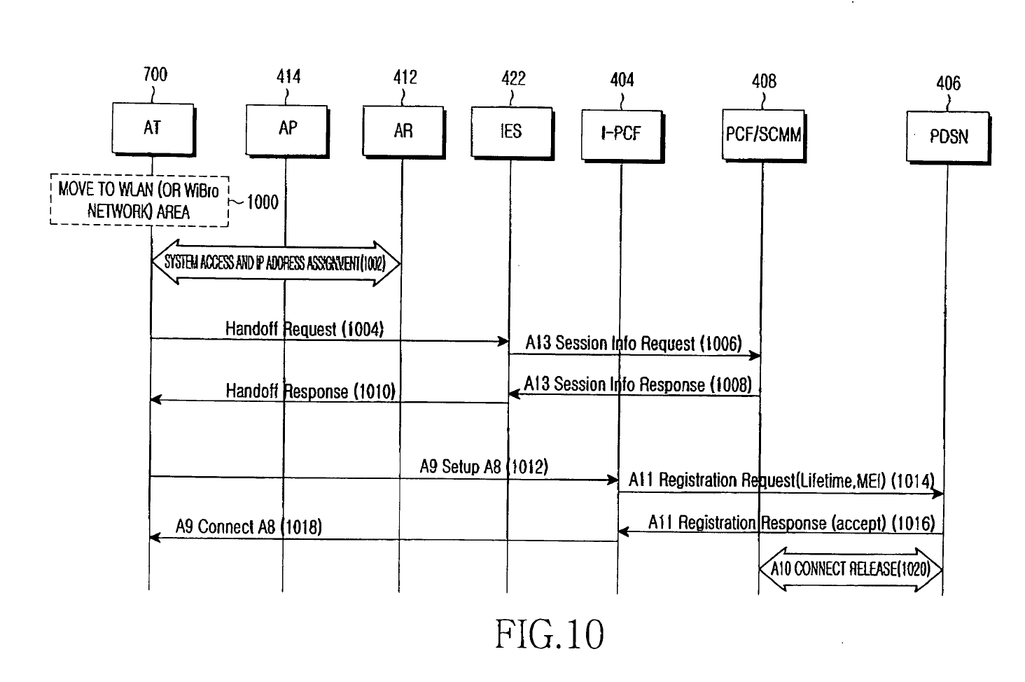

With reference to FIG. 10, a description will now be made of a method for supporting inter-network handoff occurring when an AT 700 accessing a CDMA 2000 1x EV-DO network 418 moves to coverage of a Wireless LAN 416. This type of handoff occurs at the request of a user or an application layer in an area where the Wireless LAN 416 and the CDMA 2000 1x EV-DO network 418 overlap each other, or occurs in the case where the AT 700 has completely left the coverage of the CDMA 2000 1x EV-DO network 418 and can access only the Wireless LAN 416.

FIG. 10 is a diagram illustrating an inter-network handoff procedure from a CDMA 1x EV-DO network 418 to a Wireless LAN 416 according to an exemplary embodiment of the present invention. According to an exemplary implementation, an AT 700 moves to a Wireless LAN 416 while keeping a PPP session to a PDSN 406 after succeeding in a system access procedure in coverage of a CDMA 2000 1x EV-DO network 418.

If the AT 700 moves to the Wireless LAN 416 in step 1000, it searches and accesses an adjacent AP 414 in a WLAN operating frequency band and is assigned an IP address from the AP 414 in step 1002.

In step 1004, the AT 700 generates a Handoff Request message including a UATI assigned from the CDMA 2000 1x EV-DO network 418, and delivers the generated Handoff Request message to an IES 422. A format of the Handoff Request message is shown in Table 6 below.

TABLE 6

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 4 | Length = variable | Option = 1 | Length = 4 |

IP address of access terminal

| | | |
|---|---|---|
| Option = 5 | Length = variable | . . . |

Mobile Identity
. . .

| | | |
|---|---|---|
| . . . | Option = 6 | Length = 16 |

. . .
UATI 128
. . .
. . .

In step 1006, the IES 422 that receives the Handoff Request message generates an A13 Session Information Request message and delivers the A13 Session Information Request message to a PCF/SCMM 408 to acquire session information of the AT 700. At this moment, the IES 422 can distinguish the PCF/SCMM 408 and determine an IP address of the PCF/SCMM 408 depending on a UATI included in the Handoff Request message. In the exemplary embodiment of the present invention, the IES 422 maps the UATI to an IP address of its associated PCF/SCMM 408 and stores it therein. This facilitates the determination of an IP address of the PCF/SCMM 408 mapped to the AT 700.

In FIG. 10, the PCF/SCMM 408 that the AT 700 prefers to access is a source PCF/SCMM 408 that was providing packet service to the AT 700 and that accessed the CDMA 2000 1x EV-DO network 418 before the AT 700 moves to the Wireless LAN 416.

The detailed operation of the IES 422 in steps 1004 and 1006 will be described with reference to FIG. 6. Once the Handoff Request message is received in step 1004, the AT handler 608 transmits a UATI included in the Handoff Request message to the session & profile manager 610. The session & profile manager 610 transmits an A13 Session Information Request message to acquire session information for the AT 700 from the PCF/SCMM 408 that provides packet service to the AT 700 based on the UATI.

In step 1008, the PCF/SCMM 408 that receives the A13 Session Information Request message generates an A13 Session Information Response message including session information of the AT 700 and delivers the A13 Session Information Response message to the IES 422. The session information delivered by the PCF/SCMM 408 to the IES 422 includes a Mobile Identity, an ANID, and a PDSN IP address.

In step 1010, the IES 422 that receives the A13 Session Information Response message assigns an I-PCF 404 providing packet data service to the AT 700, generates a Handoff Response message including an IP address of the I-PCF 404 and session information of the AT 700, and delivers the Handoff Response message to the AT 700. A format of the Handoff Response message is shown in Table 7 below.

TABLE 7

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 1 | 2 |

| | | | |
|---|---|---|---|
| Type = 5 | Length = variable | Option = 7 | Length = 4 |

IP address of I-PCF

The detailed operation of the IES 422 in steps 1008 and 1010 will be described with reference to FIG. 6. Once the A13 Session Information Response message is received, the A13 interface handler 604 provides session information of the AT 700 to the session & profile manager 610. The session & profile manager 610 transmits an address of the I-PCF 404 scheduled to provide packet service and session information of the AT 700 to the AT handler 608, to generate a Handoff Response message to be transmitted to the AT 700.

In step 1012, the AT 700 generates an A9 Setup A8 message and delivers the A9 Setup A8 message to the I-PCF 404. The A9 Setup A8 message includes a Mobile Identity, an ANID, and a PDSN IP address. In step 1014, the I-PCF 404 that receives the A9 Setup A8 message generates an A11 Registration Request message and transmits the A11 Registration Request message to the PDSN 406.

The operation of the I-PCF 404 in steps 1012 and 1014 will be described with reference to FIG. 5. Once the A9 Setup A8 message is received, the A8/A9 interface handler 504 generates an A8 interface for generating a GRE tunnel to the AT 700. The GRE tunnel handler 508, after selecting the PDSN 406 scheduled to provide packet service to the AT 700, allows the A10/A11 interface handler 506 to generate an A11 Registration Request message and transmit the A11 Registration Request message to the PDSN 502. The A10/A11 interface handler 506 includes a Lifetime value>0 and a Mobility Event Indicator (MEI) field in the A11 Registration Request message. The GRE tunnel handler 508 selects the PDSN 406 depending on the IP address of the PDSN 406, delivered by the AT 700. Even though the AT 700 moves to the Wireless LAN 416, the AT 700, can be connected to the same PDSN 406 as the PDSN 406 to which it was connected when it previously accessed the CDMA 2000 1x EV-DO network 418.

In step 1016, the PDSN 406 that receives the A11 Registration Request message sets up a GRE tunnel to the I-PCF 404, generates an A11 Registration Response message and delivers the A11 Registration Response message to the I-PCF 404. If the PDSN 406 has an IP packet to be transmitted to the AT 700, a Data Available Indicator (DAI) is included in the A11 Registration Response message. After steps 1014 and 1016, a GRE tunnel is set up between the PDSN 406 and the I-PCF 404.

In step 1018, the I-PCF 404 that receives the A11 Registration Response message sets up a GRE tunnel to the AT 700, generates an A9 Connect A8 message, and transmits the A9 Connect A8 message to the AT 700. The operation of the I-PCF 408 in steps 1016 and 1018 will be described with reference to FIG. 5. Once the A11 Registration Response message is received, the A10/A11 interface handler 506 allows the GRE tunnel handler 508 to set up a GRE tunnel to the PDSN 406. After the GRE tunnel to the PDSN is set up, the GRE tunnel handler 508 allows the A8/A9 interface handler 504 to generate an A9 Connect A8 message and transmit the A9 Connect A8 message to the AT 700 in order to generate a GRE tunnel to the AT 700.

In step 1020, the PDSN 406 starts an A10 connect release procedure with the PCF/SCMM 408, recognizing that Inter-PCF handoff has occurred in step 1016. The detailed contents for the A10 connect release between the PDSN 406 and the PCF/SCMM 408 follow the HRPD IOS standard.

According to the procedure described with reference to FIG. 10, if the AT 700 moves from the CDMA 1x EV-DO network 418 to the Wireless LAN 416, the old IP address used in the CDMA 2000 1x EV-DO network 418 and the session of the upper layer can be kept. This allows the AT 700 to continue to provide the old application service performed before the handoff to the user after the handoff. If the AT 700 moves from the CDMA 2000 1x EV-DO network 418 to the Wireless LAN 416 while transmitting IP traffic, the IP packet transmission is stopped while the inter-network handoff is performed. After completing the procedure of FIG. 10, the AT 700 resumes the IP packet transmission.

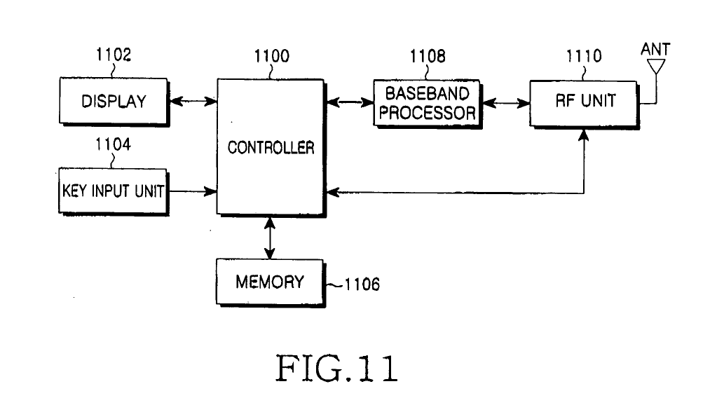

FIG. 11 is a block diagram of an AT for interworking between a cellular network and a Wireless LAN according to an exemplary embodiment of the present invention.

Referring to FIG. 11, a display 1102, under the control of a controller 1100, displays display data for key input data received from a key input unit 1104. The display 1102 displays an operating state of an AT 700 and a variety of information with an icon, a Short Message Service (SMS) message, and an image. Under the control of the controller 1100, the display 1102 provides visual information to its user to help set/activate a preferred function. In addition, the display 1102, under the control of the controller 1100, outputs a call processing-related screen, an SMS message-related screen, an Internet-related screen, and an inter-network handoff screen.

The key input unit 1104, including alphanumeric keys and various function keys, provides the controller 1100 with a key input signal input by the user. The key input unit 1104 generates a signal for a corresponding key and applies the generated signal to the controller 1100. The controller 1100 then detects which key has been input, based on the key input signal provided by the key input unit 1104, and performs the corresponding operation.

A memory 1106 connected to the controller 1100 includes a Read Only Memory (ROM) and a Random Access Memory (RAM) for storing a plurality of programs and information necessary for controlling an operation of the AT 700, and a voice memory. The memory 1106 stores IP addresses assigned from a Wireless LAN 416 and a CDMA 2000 1x EV-DO network 418, a user ID and a password of the AT 700, an ANID, a Mobile Identity, a UATI value, and IP addresses of an I-PCF 404 and a PDSN 406 according to an exemplary embodiment of the present invention. The memory 1106 also stores packets received from an AP 414 and an access network 420. According to an exemplary implementation, the memory 1106 stores a Received Signal Strength Indicator (RSSI) of a beacon message from the AP 414, based on the controller's 1100 determination of whether to perform inter-network handoff according to an exemplary embodiment of the present invention, and also stores an RSSI threshold for a signal received from the access network 420.

An RF unit 1110 exchanges RF signals with a base station such as the AP 414 or the access network 420 via an antenna. The RF unit 1110 converts a received RF signal into an intermediate frequency (IF) signal, and outputs the IF signal to a baseband processor 1108. The RF unit 1110 converts an IF signal received from the baseband processor 1108 into an RF signal, and transmits the RF signal to the base station such as the AP 414 or the access network 420.

The RF unit 1110 of FIG. 11 can include blocks (not shown) for accessing the cellular network and the Wireless LAN and performing communication with the cellular network and the Wireless LAN. The RF unit 1110 measures RSSIs for APs 414 and delivers the measured RSSIs to the controller 1100 so that the controller 1100 may determine whether to perform handoff from the cellular network 418 to the Wireless LAN 416 or from the Wireless LAN 416 to the cellular network 418 according to an exemplary embodiment of the present invention.

The baseband processor 1108, which is a Baseband Analog ASIC (BAA) for providing an interface between the controller 1100 and the RF unit 1110, converts a baseband digital signal received from the controller 1100 into an analog IF signal and provides the analog IF signal to the RF unit 1110. The baseband processor 1108 converts an analog IF signal received from the RF unit 1110 into a baseband digital signal and provides the baseband digital signal to the controller 1100. Further, the RF unit 1110 can be constructed such that it can access heterogeneous networks and perform communication with the corresponding wireless access networks according to an exemplary embodiment of the present invention.

The controller 1100 controls the overall operation of the AT 700. Once the controller 1100 accesses the Wireless LAN 416, it generates the Session Request message of FIG. 8 by including a user ID and a password, and an IP address assigned from the Wireless LAN 416 according to an exemplary embodiment of the present invention. The controller 1100 also generates the Session Update message of FIG. 8 by including an ANID, a Mobile Identity and an IP address of the AT 700, an IP address of the PDSN 406, and an IP address of the I-PCF 404.

When the AT 700 moves from the Wireless LAN 416 to the CDMA 2000 1x EV-DO network 418 according to another exemplary embodiment of the present invention, the controller 1100 includes a UATI value in the UATI Request message of FIG. 9. When the AT 700 moves from the CDMA 2000 1x EV-DO network 418 to the Wireless LAN 416 according to another exemplary embodiment of the present invention, the controller 1100 generates the Handoff Request message of FIG. 10 by including a UATI value assigned from the CDMA 2000 1x EV-DO network 418, and generates the A9 Setup A8 message of FIG. 10 by including a Mobile Identity, an ANID, and an IP address of the PDSN 406.

The controller 1100 selects an optimal wireless access network among various wireless access interfaces searched by the RF unit 1110 according to an exemplary embodiment of the present invention. In the exemplary embodiment of the present invention, if an RSSI of a beacon message transmitted by the AP 414 of the Wireless LAN 416 is higher than or equal to a threshold, the controller 1100 generates the Handoff Request message of FIG. 10, expecting that the AT 700 will move from the CDMA 2000 1x EV-DO network 418, or a cellular network, to the Wireless LAN 416. Alternatively, in the case where the AT 700 moves from the Wireless LAN 416 to the CDMA 2000 1x EV-DO network 418, if an RSSI for the access network 420 is higher than or equal to a threshold, the controller 1100 transmits the UATI Request message of FIG. 9 to the access network 420, expecting that the AT 700 will move to the CDMA 2000 1x EV-DO network 418. The controller 1100 stores in the memory 1106 information such as an IP address of the AT 700, IP addresses of the I-PCF 404 and the PDSN 406, a UATI, an ANID and a Mobile Identity, all of which are included in the received message, and also the information related to the IES 422, such as an IP address of the IES 422, provided by the mobile communication service providers.

The controller 1100 collectively manages such system parameters as synchronization, power control, and codec parameters, acquired in the CDMA 2000 1x EV-DO network 418 and the Wireless LAN 416.

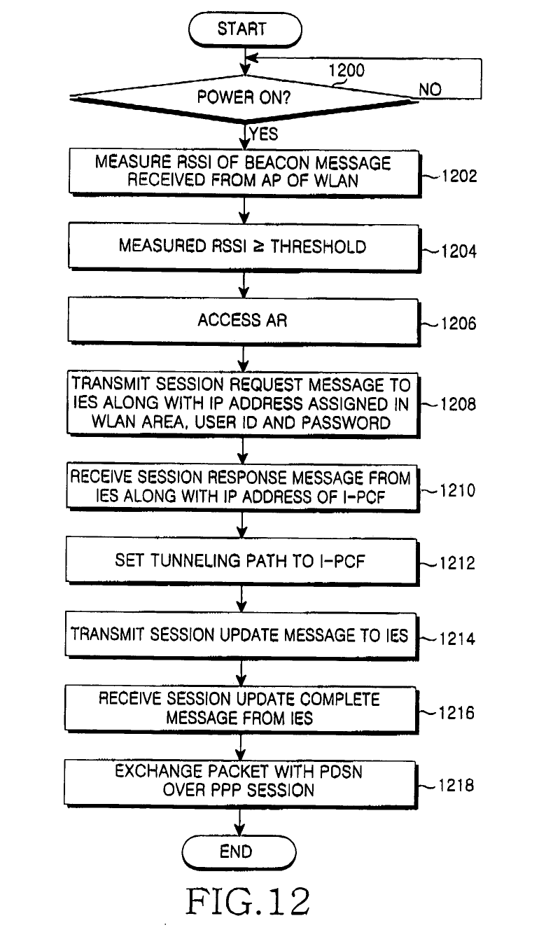

FIG. 12 is a flowchart illustrating a control flow in which an AT 700 accessing a Wireless LAN 416 receives 3G data service provided in a CDMA 2000 1x EV-DO network 418 according to an exemplary embodiment of the present invention.

If a user inputs a power-on key through a key input unit 1104 in step 1200, a controller 1100 detects a power-on signal and measures an RSSI of a beacon message from an AP 414 in step 1202. In step 1204, the controller 1100 compares the measured RSSI of the beacon message with a threshold stored in a memory 1106. If the measured RSSI is higher than or equal to the threshold, the controller 1100 accesses an AR 412 and is assigned an IP address in step 1206, recognizing that the AT 700 is located in coverage of the Wireless LAN 416.

In step 1208, the controller 1100 includes the IP address assigned from the Wireless LAN 416, and a user ID and a password in a Session Request message, and transmits the Session Request message to an IES 422. In step 1210, the controller 1100 receives a Session Response message including an IP address of an I-PCF 404 from the IES 422. The controller 1100 sets up a tunneling path to the I-PCF 404 in step 1212, and transmits a Session Update message to the IES 422 in step 1214. The controller 1100 receives a Session Update Complete message from the IES 422 in step 1216, and then sets up a PPP session to a PDSN 406 and exchanges packets with the PDSN 406 in step 1218.

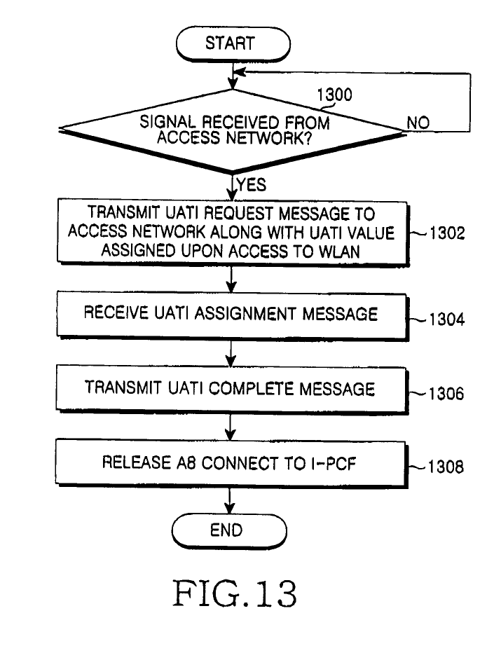

FIG. 13 is a flowchart illustrating an inter-network handoff procedure performed when an AT 700 moves from a Wireless LAN 416 to a CDMA 2000 1x EV-DO network 418 according to an exemplary embodiment of the present invention.

In step 1300 a controller determines whether an RF unit 1110 has received a signal from an access network 420. If the RF unit 1110 has received a signal, the controller 1100 transmits a UATI Request message including a UATI value assigned from the Wireless LAN 416 to the access network 420 in step 1302. The controller 1100 receives a UATI Assignment message from the access network 420 in step 1304, and transmits a UATI Complete message in step 1306. The controller 1100 releases an A8 connect to an I-PCF 414 in step 1308.

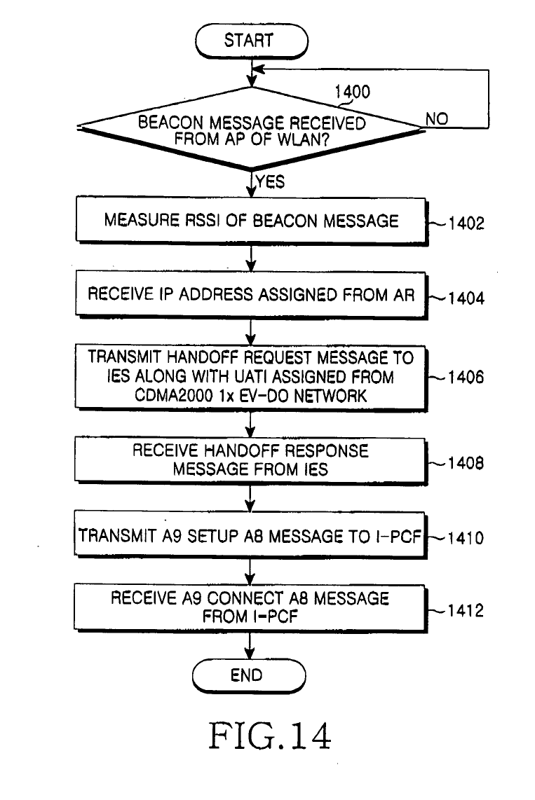

FIG. 14 is a flowchart illustrating an inter-network handoff procedure performed when an AT 700 moves from a CDMA 2000 1x EV-DO network 418 to a Wireless LAN 416 according to an exemplary embodiment of the present invention.

In step 1400 a controller determines whether a beacon message is received at an RF unit 1110 from an AP 414 of the wireless LAN 416. If a beacon message is received, the controller 1100 measures an RSSI of the received beacon message in step 1402. If the measured RSSI of the beacon message is higher than or equal to a threshold, the controller 1100 is assigned an IP address from an AR 412 in step 1404. The controller 1100 transmits a Handoff Request message including an UATI assigned from the CDMA 2000 1x EV-DO network 418 to an IES 422 in step 1406, and receives a Handoff Response message from the IES 422 in step 1408. The controller 1100 transmits an A9 Setup A8 message to an I-PCF 404 in step 1410, and receives an A9 Connect A8 message from the I-PCF 404 in step 1412.

A subscriber to a 3G data service provided in a CDMA 2000 1x EV-DO network can receive the 3G data service even when it accesses a Wireless LAN, enabling inter-network handoff. An exemplary embodiment of the present invention has the following advantages.

First, most of the existing inter-network handoff schemes use Mobile IP. Therefore, the AT and all network elements such as the PDSN and the AR should support Mobile IP, causing signaling delay, triangular routing, and traffic concentration on the Home Agent (HA). Alternatively, the new inter-network handoff scheme proposed in an exemplary embodiment of the present invention can support inter-network handoff without using Mobile IP, thereby compensating for the defects of Mobile IP.

Second, the new inter-network handoff scheme requires no change in the existing network elements and interface standards previously defined in the CDMA 2000 1x EV-DO network and the Wireless LAN. For example, the new inter-network handoff scheme can use the existing PDSN, PCF/SCMM, ANC, ANTS, AR, and AP without modification.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for providing a packet data service of a cellular network to an access terminal (AT) accessing a wireless local area network (LAN), the system comprising:
the AT for transmitting a session request message to an interworking—entry server (IES) by accessing the wireless LAN, and setting up a generic routing encapsulation (GRE) tunnel to an interworking—packet control function (I-PCF) to receive the packet data service;
the IES for performing authentication on the AT when the session request message is received from the AT, and transmitting a session response message comprising an Internet protocol (IP) address of the I-PCF to the AT; and
the I-PCF for setting up a GRE tunnel to the AT, and setting up a GRE tunnel to a packet data serving node (PDSN) that provides the packet data service to the AT, based on session information of the AT.

2. The system of claim 1, wherein the session request message comprises a user identifier (ID), a password, and an IP address assigned from the wireless LAN.

3. The system of claim 1, wherein the session response message comprises at least one of an access network identifier (ANID), a mobile node identifier (MNID) and a universal access terminal identifier (UATI) of the AT, and an IP address of the I-PCF.

4. A method for providing a packet data service of a cellular network to an access terminal (AT) accessing a wireless local area network (LAN), the method comprising the steps of:
transmitting a session request message by the AT accessing the wireless LAN;
sending an authentication request for the AT by an interworking—entry server (IES) when the session request message is received;
transmitting a session response message to the AT after completing authentication on the AT;
setting up, by the AT, a generic routing encapsulation (GRE) tunnel to an interworking—packet control function (I-PCF) when the session response message is received;
setting up, by the I-PCF, a GRE tunnel to a packet data serving node (PDSN) that provides the packet data service to the AT; and
exchanging packet data between the AT and the PDSN.

5. The method of claim 4, wherein the session response message comprises an access network identifier (ANID) of an access network to be accessed by the AT, a universal access terminal identifier (UATI), and an IP address of the I-PCF.

6. An interworking—entry server (IES) apparatus for providing to an access terminal (AT) an Internet protocol (IP) address of a selected at least one of a packet control function (PCF) and an interworking—packet control function (I-PCF) for providing a packet data service according to a type of an access network accessed by the AT, the apparatus comprising:
a transmission control protocol/Internet protocol (TCP/IP) protocol processor for handling user traffic and signaling messages delivered to at least one of an external network and the AT according to a protocol;
a first interface handler for handling signaling messages exchanged with an access network authentication authorization accounting (AN-AAA) server to perform authentication on the AT;
a second interface handler for handling signaling messages for delivering session information of the AT to a PCF of a cellular network;
an AT handler for handling signaling messages with the AT accessing a wireless local area network (LAN); and
a session & profile manager for generating and storing session information of a virtual cellular network when the AT accesses the wireless LAN, and storing a user profile received from the AN-AAA server.

7. The IES apparatus of claim 6, wherein the first interface handler handles an A12 signaling message.

8. The IES apparatus of claim 6, wherein the second interface handler handles an A13 signaling message.

9. A method for providing to an access terminal (AT) an Internet protocol (IP) address of a selected at least one of a packet control function (PCF) and an interworking—packet control function (I-PCF) for providing a packet data service according to a type of an access network accessed by the AT, the method comprising the steps of:
handling user traffic and signaling messages delivered to at least one of an external network and the AT according to a protocol;
handling a first signaling message exchanged with an access network authentication authorization accounting (AN-AAA) server to perform authentication on the AT;
handling a second signaling message for delivering session information of the AT to a PCF of a cellular network;
handling signaling messages with the AT accessing a wireless local area network (LAN); and
generating and storing session information of a virtual cellular network when the AT accesses the wireless LAN, and storing a user profile received from the AN-AAA server.

10. The method of claim 9, wherein the first signaling message comprises an A12 signaling message.

11. The method of claim 9, wherein the second signaling message comprises an A13 signaling message.

12. An interworking—packet control function (I-PCF) apparatus for providing a packet data service to an access terminal (AT) that accessed a selected at least one of a cellular network and a wireless local area network (LAN), the apparatus comprising:
a transmission control protocol/Internet protocol (TCP/IP) protocol processor for handling user traffic and signaling messages delivered to at least one of an external network and the AT according to a protocol;
a second interface handler for handling first signaling messages exchanged with an AT accessing the wireless LAN, and controlling a tunnel according to the handling result;
a fourth interface handler for handling third signaling messages exchanged with a packet data serving node (PDSN), and controlling the tunnel according to the handling result; and
a tunnel handler for at least one of generating and eliminating the tunnel using the second interface handler and the fourth interface handler, and handling packets delivered from the AT and packets delivered from the PDSN through the set tunnel.

13. The I-PCF apparatus of claim 12, wherein the first signaling message comprises an A9 signaling message, and the third signaling message comprises an A11 signaling message.

14. The I-PCF apparatus of claim 12, wherein the second interface handler comprises an A8/A9 interface handler, and the fourth interface handler comprises an A10/A11 interface handler.

15. The I-PCF apparatus of claim 12, wherein the tunnel set up between the AT and the PDSN comprises a generic routing encapsulation (GRE) tunnel.

16. A method for providing a packet data service to an access terminal (AT) that accessed a selected at least one of a cellular network and a wireless local area network (LAN), the method comprising the steps of:
handling user traffic and signaling messages delivered to at least one of an external network and the AT;
handling first signaling messages for controlling a tunnel for exchanging packet data with an AT accessing the wireless LAN;
handling second signaling messages for controlling the tunnel to a packet data serving node (PDSN);
at least one of generating and eliminating the tunnel to the AT and the PDSN according to the first signaling messages and the second signaling messages; and
handling packets delivered from the AT and the PDSN.

17. The method of claim 16, wherein the first signaling message comprises an A9 signaling message, and the second signaling message comprises an A11 signaling message.

18. The method of claim 16, wherein the tunnel comprises a generic routing encapsulation (GRE) tunnel.

19. An access terminal (AT) apparatus capable of accessing a mobile communication system based on a wireless local area network (LAN) and a cellular mobile communication system, the apparatus comprising:
a radio frequency (RF) unit for measuring a received signal strength indicator (RSSI) of a beacon message from adjacent access points and an RSSI of a signal from an access network;
a controller for, if the RSSI of the beacon message is at least one of higher than and equal to a threshold, generating a request message for inter-network handoff from the cellular mobile communication system to the wireless LAN, transmitting the request message to an interworking—entry server (IES), and after completion of the inter-network handoff, generating a generic routing encapsulation (GRE) tunnel to an interworking—packet control function (I-PCF) with which the AT will exchange packets; and
a memory for storing session information of the AT accessing the wireless LAN, and an Internet protocol (IP) address of the I-PCF.

20. The AT apparatus of claim 19, wherein if the RSSI of the signal from the access network is at least one of higher than and equal to a threshold, the controller transmits a universal access terminal identifier (UATI) request message to access the cellular mobile communication system and after completion of the inter-network handoff, generates a GRE tunnel to a packet control function (PCF) with which the AT will exchange packets, and the memory stores a mobile identity, an access network identifier (ANID), and an IP address of the PCF when the AT accesses the cellular mobile communication system.

21. The AT apparatus of claim 19, wherein the AT first accesses the wireless LAN, the controller generates a session request message to receive a session assigned from the wireless LAN, transmits the session request message to the IES, and generates a GRE tunnel to the I-PCF with which the AT will exchange packets, and the memory stores an IP address of the AT, received from the wireless LAN, an ANID, a mobile identity, and IP addresses of the I-PCF and a packet data serving node (PDSN), with which the AT will exchange packets.

22. A method for accessing, by an access terminal (AT), a wireless local area network (LAN) and exchanging packets of a cellular network with the wireless LAN, the method comprising the steps of:
measuring a received signal strength indicator (RSSI) of a beacon message from adjacent access points;
transmitting a session request message to an interworking—entry server (IES) if the RSSI of the beacon message is at least one of higher than and equal to a threshold;
setting up a tunnel to an interworking—packet control function (I-PCF) based on the session response message when a session response message is received from the IES; and
exchanging packets through the set tunnel.

23. The method of claim 22, wherein the session request message comprises at least one of an Internet protocol (IP) address assigned from the wireless LAN, a user identifier (ID), and a password.

24. The method of claim 22, wherein the session response message comprises an IP address of the I-PCF.

25. A system for providing a handoff service to an access terminal (AT) moving from a wireless local area network (LAN) to a cellular network, the system comprising:
the AT for transmitting a universal access terminal identifier (UATI) request message to access the cellular network;
a packet control function (PCF) for transmitting a session information request message to an interworking—entry server (IES) to acquire session information of the AT when the UATI request message is received from the AT and a PCF for completing a session initialization procedure with the AT; and
the IES for transmitting a session information response message comprising the session information of the AT to the PCF when the session information request message is received; and

26. The system of claim 25, wherein the UATI request message comprises a UATI assigned from the wireless LAN.

27. A method for providing a handoff service to an access terminal (AT) moving from a wireless local area network (WLAN) to a cellular network, the method comprising the steps of:
transmitting, by the AT, a universal access terminal identifier (UATI) request message to access the cellular network;
sending, by a packet control function (PCF), a request for session information of the AT to an interworking—entry server (IES) when the UATI request message is received;
transmitting, by the IES, a session information response message for the AT to the PCF; and
exchanging, by the AT, packet data with a packet data serving node (PDSN) when the session information response message is received.

28. The method of claim 27, wherein the session information response message comprises an access network identifier (ANID) of an access network to be accessed by the AT, a UATI, and an Internet protocol (IP) address of the PDSN.

29. A system for providing a handoff service to an access terminal (AT) moving from a cellular network to a wireless local area network (LAN), the system comprising:
the AT for transmitting a handoff request message to an interworking—entry server (IES) along with an Internet protocol (IP) address assigned from the wireless LAN, and setting up a generic routing encapsulation (GRE) tunnel to an interworking—packet control function (I-PCF) to receive a packet data service;
the IES for, when the handoff request message is received from the AT, sending a request for session information of the AT to a packet control function (PCF), and transmitting to the AT an IP address of the I-PCF scheduled to provide the packet data service to the AT; and
the I-PCF for setting up a tunnel to the AT and a packet data serving node (PDSN) to provide the packet data service.

30. The system of claim 29, wherein the tunnel set up between the AT and the PDSN by the I-PCF comprises a GRE tunnel.

31. A method for providing a handoff service to an access terminal (AT) moving from a cellular network to a wireless local area network (LAN), the method comprising the steps of:
accessing, by the AT, the wireless LAN and transmitting a handoff request message;
sending, by an interworking—entry server (IES), session information of the AT to a packet control function (PCF) when the handoff request message is received;
assigning, by the IES, an interworking—packet control function (I-PCF) scheduled to provide a packet data service to the AT when a session response message for the AT is received from the PCF; and
setting up, by the I-PCF, a tunnel to the AT and a packet data serving node (PDSN) that exchanges packet data with the AT.

32. The method of claim 31, wherein the session response message comprises an Internet protocol (IP) address of the I-PCF, to which the AT will set up a tunnel.

33. The method of claim 31, wherein the tunnel set up to the AT and the PDSN by the I-PCF comprises a generic routing encapsulation (GRE) tunnel.

34. A method for accessing, by an access terminal (AT), a wireless local area network (LAN) and exchanging packets of a cellular mobile communication system with the wireless LAN, the method comprising the steps of:
measuring a received signal strength indicator (RSSI) of a beacon message from adjacent access points and an RSSI of a signal from an access network;
generating a request message for inter-network handoff from the cellular mobile communication system to the wireless LAN if the RSSI of the beacon message is at least one of higher than and equal to a threshold;
setting up a tunnel to an interworking—packet control function (I-PCF) scheduled to provide a packet data service in the wireless LAN after completion of the inter-network handoff; and
accessing the wireless LAN, and storing session information and an Internet protocol (IP) address of the I-PCF.

35. The method of claim 34, further comprising the steps of:
if the RSSI of the signal from the access network is higher than or equal to a threshold, transmitting a universal access terminal identifier (UATI) request message to access the cellular mobile communication system and after completion of the inter-network handoff, setting up a tunnel to a packet control function (PCF), with which the AT will exchange packets; and
upon its access to the cellular mobile communication system, storing a mobile identity, an access network identifier (ANID), and an IP address of the PCF.

36. The method of claim 34, further comprising the steps of:
upon its first access to the wireless LAN, generating a session request message to receive a session assigned from the wireless LAN, and setting up a tunnel to the I-PCF, with which the AT will exchange packets; and
storing an IP address of the AT, received from the wireless LAN, an ANID, a mobile identity, and IP addresses of the I-PCF and a packet data serving node (PDSN), with which the AT will exchange packets.

37. The method of claim 34, wherein the tunnel comprises a generic routing encapsulation (GRE) tunnel.
